(19) United States
(12) Patent Application Publication
(10) Pub. No.: US 2021/0293291 A1
(43) Pub. Date: Sep. 23, 2021

(54) FRICTION MEMBER, FRICTION MATERIAL COMPOSITION FOR LOWER LAYER MATERIAL, LOWER LAYER MATERIAL, DISC BRAKE PAD, AND VEHICLE

(71) Applicant: SHOWA DENKO MATERIALS CO., LTD., Chiyoda-ku, Tokyo (JP)

(72) Inventors: Yoshihisa TAKAHASHI, Chiyoda-ku, Tokyo (JP); Mitsuo UNNO, Chiyoda-ku (JP)

(73) Assignee: SHOWA DENKO MATERIALS CO., LTD., Chiyoda-ku, Tokyo (JP)

(21) Appl. No.: 17/260,138

(22) PCT Filed: Jul. 24, 2018
(86) PCT No.: PCT/JP2018/027779

§ 371 Date: Jan. 13, 2021

(51) Int. Cl. F16D 65/092; F16D 69/02

(52) U.S. Cl. CPC F16D 65/092; F16D 69/026; F16D 2200/0047; F16D 2200/003; F16D 2200/0065

(57) ABSTRACT

Provided is a friction member (such as a disc brake pad) having light weight by reducing weight of a back plate and having improved durability after repeated braking. The friction member is specifically a friction member in which a friction material (overlying material) is disposed through an underlying material on one surface of a back plate comprising a material having a lower specific gravity than that of steel, wherein the underlying material comprises 30 mass % or more in total of a bonding material, an organic filler, and an organic fiber.

### TECHNICAL FIELD

The present invention relates to a friction member, a friction material composition for an underlying material, an underlying material, a disc brake pad, and a vehicle.

### BACKGROUND ART

An example of a disc brake pad as a friction member for braking mounted on a two-wheeled vehicle, a four-wheeled automobile, and the like is shown in FIG. 1 and FIG. 2. FIG. 1 is a top view of the disc brake pad, and FIG. 2 is an example of a cross-sectional view taken along a line A-A of FIG. 1. In this example, the disc brake pad is composed of a back plate 1 and a friction material 2, and the friction material 2 is directly and firmly fixed to one surface 11 of the back plate 1 (an upper surface of the back plate 1 in this example). The friction material 2 is, for example, made of a so-called resin molded material containing a bonding material, an organic filler, an inorganic filler, and a fibrous base material. Such a disc brake pad is produced by stacking preformed products of the friction material containing a bonding material, an organic filler, an inorganic filler, and a fibrous base material on one surface of the back plate 1 prior to hot press molding for integrally and firmly fixing them to each other, followed by a surface treatment.

Further, another example of the disc brake pad is shown in FIG. 3. FIG. 3 is another example of a cross-sectional view taken along the line A-A of FIG. 1. The disc brake pad in FIG. 3 is composed of a back plate 1, a friction material (also referred to as “overlying material” in the case of FIG. 3.) 2, and an underlying material 3, and the friction material (overlying material) 2 is firmly fixed to one surface 11 of the back plate 1 (an upper surface of the back plate 1 in this example) through the underlying material 3. In this case, the disc brake pad is produced by stacking preformed products of the friction material containing a bonding material, an organic filler, an inorganic filler, and a fibrous base material and the underlying material on one surface of the back plate 1 prior to hot press molding for integrally and firmly fixing them to each other, followed by a surface treatment.

With recent advances in an environmentally-friendly and fuel-efficient automobile, a weight reduction of automotive parts has been studied and put into practice. Although metallic materials generally make up more than half of the raw materials used for an automobile, an amount of the metallic materials used for automobiles has been slowly decreasing year by year due to a weight reduction of a car body. For reducing the weight of a car body, there has recently been a growing trend to use aluminum (an aluminum alloy or an aluminum composite) or a resin as a material. A steel plate has a specific gravity of approximately 7.8 Mg/m³, and aluminum and a resin, on the other hand, have a specific gravity of approximately 2.7 Mg/m³ and approximately 1 Mg/m³, respectively, and are therefore lighter than a steel plate. Thus, it is expected that the weight of a car body is reduced to 50% or less by using materials such as aluminum and a resin. In the movement of the weight reduction as described above, there has been a growing demand for the weight reduction of not only a body and a frame of a vehicle, but also the other elements composing a vehicle.

Such a demand for reducing the weight of a car body has also been growing in a disc brake pad which is one of the composing elements of braking system used for braking a vehicle. Specifically, although a back plate made of a steel plate material has been conventionally used for a disc brake pad, a resin-made back plate has recently been proposed. For example, a molded product produced by compressing a phenolic resin containing glass fibers of approximately 0.1 to 10 mm has been proposed (see PTLs 1 and 2).

### CITATION LIST

### Patent Literature

PTL 1: JP 2001-165210 A

PTL 2: JP 2001-253998 A

### SUMMARY OF INVENTION

### Technical Problem

The present inventors conducted a study to replace the conventional steel back plate with a back plate made of a resin or an aluminum lightweight material for the weight reduction of the disc brake pad, and consequently found that these lightweight materials have insufficient durability after repeated braking as compared to that of the conventional steel back plate.

Based on the above, an object of the present invention is to provide a friction member (such as a disc brake pad) having light weight by reducing weight of a back plate with improved durability after repeated braking.

### Solution to Problem

The present inventors made an extensive research to achieve the above object, and completed the present invention by finding out that a total content of a specific component comprised in an underlying material can be equal to or more than a predetermined value to result in an improvement in durability of a back plate after repeated braking, even in a reduction in weight of the back plate, and eventually result in an improvement in durability of a friction member after repeated braking. The present invention was completed based on the above finding.

The present invention relates to [1] to [14] below.

[1] A friction member in which a friction material (overlying material) is disposed through an underlying material on one surface of a back plate comprising a material having a lower specific gravity than that of steel, wherein the underlying material comprises 30 mass % or more in total of a bonding material, an organic filler, and an organic fiber.

[2] The friction member according to [1], wherein a content of the organic filler in the underlying material is 10 mass % or more.

[3] The friction member according to [1] or [2], wherein the underlying material further comprises at least one selected from the group consisting of an inorganic filler and an inorganic fiber.

[4] The friction member according to any one of [1] to [3], wherein the specific gravity of the material contained in the back plate is 5 Mg/m³ or less.

[5] The friction member according to any one of [1] to [4], wherein the back plate comprises at least one selected from the group consisting of (1) a fiber-reinforced resin, (2-1) an aluminum alloy, (2-2) an aluminum composite in which ceramic particles are dispersed in aluminum or an aluminum alloy, (3-1) a magnesium alloy, and (3-2) a magnesium composite in which ceramic particles are dispersed in magnesium or a magnesium alloy.

[6] The friction member according to [5], wherein the back plate comprises the fiber-reinforced resin (1) or the aluminum alloy (2-1).

[7] A disc brake pad comprising the friction member according to any one of [1] to [6].

[8] A vehicle comprising the friction member according to any one of [1] to [6].

[9] A friction material composition for an underlying material, wherein the friction material composition comprises 30 mass % or more in total of a bonding material, an organic filler, and an organic fiber.

[10] The friction material composition for an underlying material according to [9], wherein a content of the organic filler is 10 mass % or more.

[11] The friction material composition for an underlying material according to [9] or [10], further comprising at least one selected from the group consisting of an inorganic filler and an inorganic fiber.

[12] The friction material composition for an underlying material according to any one of [9] to [11], wherein the friction material composition comprises no copper, or, even if comprising copper, comprises copper at a content of less than 0.5 mass % in terms of a copper element.

[13] An underlying material obtained by molding the friction material composition for an underlying material according to any one of [9] to [12].

[14] A vehicle comprising the underlying material according to [13].

### Advantageous Effects of Invention

According to the present invention, a friction member (such as a disc brake pad) having light weight by reducing weight of a back plate and having improved durability after repeated braking can be provided. Further, because the specific gravity of the back plate is lower than that of steel, it contributes to a weight reduction of a car body of a two-wheeled vehicle, a four-wheeled automobile, and the like by reducing the weight of the friction member such as a disc brake pad.

### BRIEF DESCRIPTION OF DRAWINGS

FIG. 1 is a schematic diagram (top view) of a friction member (disc brake pad).

FIG. 2 is a schematic diagram of a cross-sectional view taken along a line A-A of the friction member (disc brake pad) in FIG. 1 having a friction material directly disposed on one surface of a back plate.

FIG. 3 is a schematic diagram of a cross-sectional view taken along a line A-A of the friction member (disc brake pad) in FIG. 1 having a friction material (overlying material) disposed through an underlying material on one surface of a back plate.

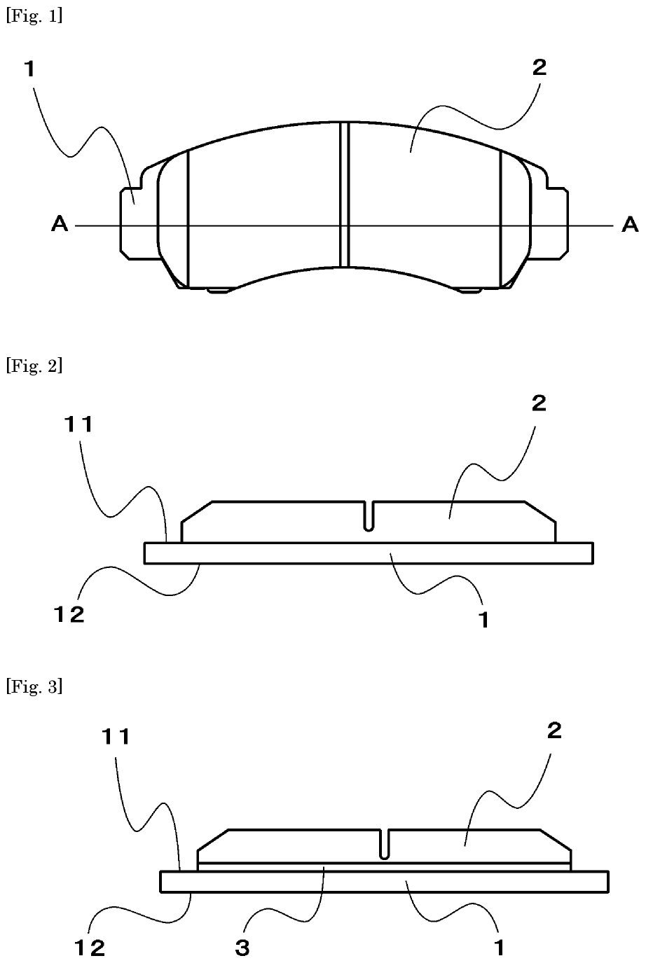

### DESCRIPTION OF EMBODIMENTS

Hereinafter, the present invention will be described in detail. However, composing elements in the following embodiments are not essential unless explicitly stated. The same applies to values and their ranges, and the present invention is not limited to these values and ranges.

As for the numerical ranges described in the present specification, an upper limit or a lower limit of the numerical ranges may be replaced with the value given in Examples. Further, in this specification, a content of components in an underlying material or a friction material composition for an underlying material refers a total content of a plural kinds of substances present in the underlying material or the friction material composition for an underlying material if the plural kinds of substances corresponding to the components are present unless otherwise specified.

Embodiments produced by combining any items described in this specification are also included in the present invention.

The study conducted by the present inventors revealed that when braking is performed repeatedly, a brake temperature is increased due to frictional heat, a surface temperature of the friction material is brought to approximately 600° C. or more in some cases, and especially when the friction material is worn away and a remaining thickness of the friction material becomes thin, a temperature of the back plate may increase to 200° C. or more in some cases. The study further revealed that in a back plate formed of a fiber-reinforced resin among the lightweight materials, thermal decomposition of the resin is triggered when the temperature of the back plate goes beyond a heatproof temperature of the resin, and this causes a significant decrease in strength of the back plate and a defect such as generation of a crack and a fracture to be easily formed. In a back plate formed of a lightweight material such as an aluminum alloy, an aluminum composite, a magnesium alloy, or a magnesium composite, when the temperature reaches 200° C. or more, strength and elasticity modulus of the back plate are decreased significantly, which is likely to result in a defect such as deformation and breakage. However, when the friction member described in the embodiment of the present invention is used, the temperature increase of the back plate 1 made of a lightweight material is prevented, and even when the surface temperature of the friction material 2 is 600° C. or more, a crack and a fracture can be prevented from forming on the back plate 1. Therefore, it becomes possible for the friction member to have a good balance of light weight and durability after repeated braking.

One embodiment of the present invention is explained by referring to FIG. 3. A friction member in which a friction material (overlying material) 2 is disposed through an underlying material 3 on one surface of a back plate 1 comprising a material having a lower specific gravity than that of steel, wherein the underlying material 3 comprises 30 mass % or more in total of a bonding material, an organic filler, and an organic fiber.

First, the back plate 1 will be described in detail.

### [Back Plate]

A back plate comprises a material having a lower specific gravity than that of steel. The back plate preferably comprises 50 volume % or more, more preferably 80 volume % or more, further preferably 90 volume % or more of a material having a lower specific gravity than that of steel, and particularly preferably is made of a material having a lower specific gravity than that of steel. The material having a lower specific gravity than that of steel is preferably a material having a specific gravity of 5 Mg/m³ or less, more preferably a material having a specific gravity of 3 Mg/m³ or less, and further preferably a material having a specific gravity of 2 Mg/m³ or less. Further, the specific gravity of the back plate is preferably 5 Mg/m³ or less, more preferably 3 Mg/m³ or less, and further preferably 2 Mg/m³ or less.

Examples of the material having a lower specific gravity than that of steel include (1) a fiber-reinforced resin, (2-1) an aluminum alloy, (2-2) an aluminum composite in which ceramic particles are dispersed in aluminum or an aluminum alloy, (3-1) a magnesium alloy, and (3-2) a magnesium composite in which ceramic particles are dispersed in magnesium or a magnesium alloy. That is, the back plate may contain at least one selected from the group consisting of the materials (1), (2-1), (2-2), (3-1), and (3-2), and may be made of at least one selected from the group consisting of the materials (1), (2-1), (2-2), (3-1), and (3-2). Among them, the fiber-reinforced resin (1) or the aluminum alloy (2-1) is preferable as the material having a lower specific gravity than that of steel.

### ((1) Fiber-Reinforced Resin)

A fiber-reinforced resin refers to a combined material of a fiber and a resin, or in other words, a composite of a fiber and a resin. The fiber-reinforced resin has a specific gravity of approximately 1 Mg/m³, and is thus suitable as a lightweight material.

As the fiber used for a fiber-reinforced resin, at least one selected from the group consisting of an inorganic fiber such as a glass fiber, an alumina fiber including an α-alumina fiber and a γ-alumina fiber, and a boron fiber; an aramid fiber such as a para-aramid fiber and a meta-aramid fiber; a cellulose fiber, a nanocellulose fiber, and a PBO (poly para-phenylenebenzoxazole) fiber, or a flameproof fiber and a carbon-based fiber such as a carbon fiber including a pitch carbon fiber and a PAN (polyacrylonitrile) carbon fiber can be used, for example. When these fibers are particularly used for the back plate, the glass fiber and the carbon fiber are preferably used in terms of strength and rigidity, and the carbon fiber is further preferably used in terms of high heat conductivity. Use of the carbon fiber allows the heat conductivity of the back plate to be further improved and allows a temperature distribution on the back plate to be even to prevent a local temperature increase when the brake temperature is increased due to frictional heat caused by repeated braking. Accordingly, cracks and fractures caused by the thermal decomposition and a decrease in strength of the resin are more likely to be prevented from forming on the back plate.

A fiber length of the fiber used for the fiber-reinforced resin is not limited to a particular length, and is preferably a fiber length of 1 mm or more, and further preferably a fiber length of 10 mm or more. An upper limit of the fiber length of the fiber is not limited to a particular length, and may be 100 mm or less, 70 mm or less, 50 mm or less, or 35 mm or less.

As the fiber used for the fiber-reinforced resin, a non-woven cloth such as a felt and even a woven cloth such as a paper product, a woven fabric made of continuous fibers, a knit fabric, and a union cloth can be used.

As the resin used for the fiber-reinforced resin, a thermosetting resin is preferred in terms of heat resistance, and a phenolic resin, an epoxy resin, and a polyimide resin are preferred in terms of heat resistance and strength. The phenolic resin and the epoxy resin, here used, can be any resin of novolak and resol resins. In a case where the epoxy resin or the phenolic resin is a novolak resin, a curing agent is preferably used in combination. These resins used for the fiber-reinforced resin may be used alone or in combination of two or more. The phenolic resin can be a commercially available product and can be produced by synthesizing using an ordinary method.

Examples of the phenolic resin include a resol phenolic resin, a straight novolak phenolic resin, an aralkyl-modified phenolic resin, an elastomer-modified phenolic resin modified by acrylic elastomer or silicone elastomer. As the phenolic resin, the straight novolak phenolic resin and the resol phenolic resin are preferred in terms of heat resistance.

The epoxy resin can be a commercially available product and can be produced by synthesizing using an ordinary method. As the epoxy resin, an epoxy resin having an aromatic ring is preferred in terms of strength and heat resistance. Specifically, a phenol novolak epoxy resin, a cresol novolak epoxy resin, a naphthalene epoxy resin, and the like can be suitably used. In addition, an epoxy resin modified by silicone, acrylonitrile, butadiene, an isopropyl rubber, a polyamide resin, or the like can be used.

Further, in addition to the above-described fibers and resins, other additives can be blended in the fiber-reinforced resin. Examples of the additives include an inorganic filler, an organic filler, and metallic powder. The additives can be used alone or in combination of two or more. A particulate inorganic filler, organic filler, and metallic powder are preferred, and a particle size is preferably so low that particles are dispersed in a fiber aggregate. Specifically, examples of such additives include graphite, a molybdenum disulfide, a tungsten sulfide, a fluorine resin, and coke in terms of improving sliding properties, a magnesium hydroxide, an aluminum hydroxide, and an antimony compound in terms of improving flame resistance, hollow inorganic particles in terms of weight reduction, a calcium oxide, and a calcium hydroxide in terms of improving a curing rate of a resin, and metallic powder, graphite, a magnesium oxide, and a zinc oxide in terms of improving heat conductivity.

To prevent a local temperature increase of the back plate, heat conductivity in a thickness direction of the fiber-reinforced resin is preferably 0.30 W/m·K or more, more preferably 0.35 W/m·K or more, and further preferably 0.40 W/m·K or more. Examples of a method for keeping the heat conductivity in a thickness direction of the fiber-reinforced resin within the above range include a method in which an additive having high heat conductivity such as metallic powder, graphite, a magnesium oxide, and a zinc oxide is added to the fiber-reinforced resin, and a method in which a fiber having high heat conductivity such as a carbon fiber is used as a fiber for the fiber-reinforced resin. The fiber-reinforced resin produced by employing the above method alone or a combination of two or more methods can be used.

In the present invention, the thickness direction refers to a direction from the surface of a friction material which is in sliding contact with a counterpart material toward a back plate, and the heat conductivity refers to heat conductivity measured by a temperature gradient method at room temperature (25° C.). The temperature gradient method is a method for measuring heat conductivity of a sample based on a heat flux and a temperature of the sample when the sample that has been brought into contact with two objects each having a different temperature reaches a stationary state, and the heat conductivity measured by the temperature gradient method can be measured with a commercially available measurement device. Specific examples of the heat conductivity measured by the temperature gradient method include a heat conductivity measured by the method described in Examples.

When the fiber-reinforced resin is used for the back plate, a fiber-reinforced resin-made back plate is produced by molding a fiber-reinforced resin and shaping the molded fiber-reinforced resin as necessary, and then, the produced fiber-reinforced resin-made back plate is used in place of a conventional steel back plate to produce the friction member. That is, a friction material composition that has been preformed as necessary is injected into a cavity of a thermoforming metal mold of a friction material, and the back plate made of the fiber-reinforced resin on which an adhesive is applied beforehand is then disposed so as to be in contact with the preformed product. The friction material (overlying material) and the underlying material are formed by subjecting the friction material composition to thermoforming, which allows the fiber-reinforced resin and the friction material to be integrated in one piece through the underlying material, thereby forming a friction member. According to the above process, thermoforming of the back plate made of the fiber-reinforced resin and thermoforming of the friction material (overlying material) and the underlying material are performed separately, which is not necessarily good in terms of energy efficiency. The energy efficiency can be improved by performing the thermoforming of the back plate made of the fiber-reinforced resin and the thermoforming of the friction material (overlying material) and the underlying material at the same time. That is, the fiber-reinforced resin that has not been thermally cured and the friction material composition that has been preformed as necessary are injected and subjected to thermoforming at the same time, so that a thermosetting resin in the fiber-reinforced resin and a thermosetting resin in the friction material are melted and cured during the thermosetting process, and are therefore integrated in one piece without an adhesive.

### (Aluminum, Aluminum Alloy)

Although aluminum is suitable as a lightweight material because of its low specific gravity of approximately 2.7 Mg/m³, an aluminum alloy is preferably used as a back plate in terms of strength. Examples of the aluminum alloy include a wrought aluminum alloy such as a 2XXX series (Al—Cu alloys), a 3XXX series (Al—Mn alloys), a 4XXX series (Al—Si alloys), a 5XXX series (Al—Mg alloys), a 6XXX series (Al—Mg—Si alloys), and a 7XXX series (Al—Zn alloys); a foundry aluminum alloy such as AC1C (Al—Cu alloys), AC1B (Al—Cu alloys), AC2A (Al—Cu—Si alloys), AC2B (Al—Cu—Si alloys), AC3A (Al—Si alloys), AC4A and AC4C (Al—Si—Mg alloys), AC4B (Al—Si—Cu alloys), AC4D (Al—Si—Cu—Mg alloys), AC5A (Al—Cu—Ni—Mg alloys), AC7A (Al—Mg alloys), AC8A (Al—Si—Cu—Ni—Mg alloys), AC8B (Al—Si—Cu—Ni—Mg alloys), AC9A (Al—Si—Cu—Mg alloys), and AC9B (Al—Si—Cu—Mg alloys); and a die-cast aluminum alloy such as ADC1 (Al—Si alloys), ADC3 (Al—Si—Mg alloys), ADC5 (Al—Mg alloys), ADC6 (Al—Mg—Mn alloys), ADC10 (Al—Si—Cu alloys), ADC12 (Al—Si—Cu alloys), and ADC14 (Al—Si—Cu—Mg alloys). In addition, thermally refined alloys produced by subjecting the above alloys to a heat treatment (aging treatment) can be used.

### (Aluminum Composite)

An aluminum composite in which ceramic particles are dispersed in aluminum or the above aluminum alloy (ceramic particle-reinforced aluminum-based composite material) has higher Young's modulus than that of an aluminum alloy. For that reason, use of the aluminum composite as a back plate can increase rigidity of a brake pad, and is thus suitable. Examples of dispersion-strengthened ceramic particles include an oxide ceramic such as Al₂O₃, TiO₂, SiO₂, and ZrO₂, a carbide ceramic such as SiC and TiC, and a nitride ceramic such as TiN.

### (Magnesium, Magnesium Alloy)

Although magnesium is suitable as a lightweight material because of its low specific gravity of approximately 1.74 Mg/m³, a magnesium alloy is preferably used as a back plate in terms of strength. Examples of the magnesium alloy include various casting magnesium alloys such as M1 (Mg—Mn alloy), AZ alloys (Mg—Al—Zn alloy) such as AZ61 and AZ91, ZK alloys (Mg—Zn—Zr alloy) such as ZK51 and ZK60, ZH alloys (Mg—Zn—Zr alloy) such as ZH62, EK alloys (Mg-Rare earth element alloy) such as EK30, HK alloys (Mg—Th alloys) such as HK31, and K1 (Mg—Zr alloy), and magnesium alloys for processing. Further, a flame-resistant magnesium alloy containing a few percent of calcium can be used.

### (Magnesium Composite)

An aluminum composite in which ceramic particles are dispersed in magnesium or the above magnesium alloy (ceramic particle-reinforced magnesium-based composite material) has higher Young's modulus than that of a magnesium alloy. For that reason, use of the aluminum composite as a back plate can increase rigidity of a brake pad, and is thus suitable. Examples of dispersion-strengthened ceramic particles include an oxide ceramic such as Al₂O₃, TiO₂, SiO₂, and ZrO₂, a carbide ceramic such as SiC and TiC, and a nitride ceramic such as TiN.

An increase in the heat conductivity in a thickness direction of the back plate allows a temperature distribution on the back plate to be even to prevent a local temperature increase when the brake temperature is increased due to frictional heat caused by repeated braking. Accordingly, cracks and fractures caused by the thermal decomposition and a decrease in strength of a resin are more likely to be prevented from forming on the back plate. For that reason, the heat conductivity in a thickness direction of the back plate is preferably 0.30 W/m·K or more, more preferably 0.35 W/m·K or more, and further preferably 1.0 W/m·K or more. An upper limit of the heat conductivity in a thickness direction of the back plate is not limited to particular heat conductivity, and may be 400 W/m·K or less, 250 W/m·K or less or 150 W/m·K or less.

Next, the material for use in the underlying material 3 (hereinafter, referred to as “friction material composition for an underlying material”.) will be described in detail. The present invention also provides an underlying material obtained by molding the friction material composition for an underlying material, and each component that can be comprised in the “friction material composition for an underlying material” corresponds to a component that can be comprised in the “underlying material”. That is, the description with respect to each component in the “friction material composition for an underlying material” described below can be read as the description with respect to each component in the “underlying material”.

### [Friction Material Composition for Underlying Material]

The friction material composition for an underlying material for use in the present invention is a friction material composition for an underlying material, the friction material comprising 30 mass % or more in total of a bonding material, an organic filler, and an organic fiber.

A preferred embodiment of the friction material composition for an underlying material for use in the present invention is a friction material composition for an underlying material, the composition not only comprising 30 mass % or more in total of a bonding material, an organic filler, and an organic fiber, but also comprising at least one selected from the group consisting of an inorganic filler and an inorganic fiber, and a more preferred embodiment thereof is a friction material composition for an underlying material, the composition not only comprising 30 mass % or more in total of a bonding material, an organic filler, and an organic fiber, but also comprising an inorganic filler and an inorganic fiber.

While it is known that a friction material comprising copper or a copper alloy is favorable for providing strength of a friction material, it is suggested that for such a friction material comprising copper or a copper alloy, an abrasion powder generated by braking comprises a large amount of copper and thus causes pollution of a river, a lake, seawater, and/or the like, and the law restricting the amount of a copper component used in a friction material (overlying material) is executed in the United States, in particular, mainly Washington and California. Therefore, a friction material usable in foreign countries including the United States is required to comprise no copper or to be significantly reduced in the content of copper, and a friction material comprising copper is currently of low commercial value. Therefore, the friction material composition for an underlying material of the present invention preferably comprises no copper, and, even if comprising copper, can comprise copper at a content of less than 0.5 mass % in terms of a copper element in the friction material composition for an underlying material, thereby not causing any occurrence of pollution in a river and/or the like, even if released in the form of an abrasion powder in the environment. The content of copper here means the content of a copper element (Cu) comprised in, for example, fibrous and powdery copper, a copper alloy, and a copper compound in the entire friction material composition for an underlying material. The content of copper in the friction material composition for an underlying material is more preferably 0.2 mass % or less and further preferably 0.05 mass % or less in terms of a copper element.

From the foregoing, it is preferred that the friction material composition for an underlying material of the present invention comprises no copper or, even if comprising, comprises copper at a content of less than 0.5 mass % in terms of a copper element.

In a case where an iron-based metal such as an iron fiber is removed from an underlying material, there is a tendency not to cause the problem of, for example, deterioration in durability due to rusting at an adhesion interface with a back plate. Therefore, an inorganic fiber has been tried to be used instead without any use of a metallic fiber, but no toughness is obtained unlike the case of a metallic fiber, and it has been found that, for example, the problem of deterioration in shear strength at ordinary temperature or high temperature (for example, 200° C. or more) and the problem of deterioration in cracking resistance can be newly caused. The iron-based metal here refers to any metal which comprises iron as a main component and which is common iron and steel, and the content of iron means the content of an iron element (Fe) comprised in iron, an iron alloy, and an iron compound in the entire friction material composition for an underlying material.

The friction material composition for an underlying material of the present invention preferably comprises no iron-based metal in terms of, for example, avoidance of deterioration in durability due to rusting, and, even if comprising an iron-based metal, can comprise an iron-based metal at a content of less than 0.5 mass % in terms of an iron element in the friction material composition for an underlying material, and thus can be favorable in rust resistance and suppressed in deterioration in durability due to rusting at an adhesion interface with a back plate. In the present invention, even in a case where the content of an iron-based metal is decreased in the range, sufficient toughness, high shear strength at ordinary temperature or high temperature, favorable cracking resistance, and favorable abrasion resistance are achieved. The content of an iron-based metal in the friction material composition for an underlying material is more preferably 0.2 mass % or less and further preferably 0.05 mass % or less in terms of an iron element.

From the foregoing, it is preferred that the friction material composition for an underlying material of the present invention also comprises no iron-based metal or, even if comprising, comprises an iron-based metal at a content of less than 0.5 mass % in terms of an iron element.

The friction material composition for an underlying material of the present invention is classified to a NAO (Non-Asbestos-Organic) material, and is a so-called non-asbestos friction material composition (a friction material composition comprising no asbestos or, if comprising, comprising a slightly trace content of asbestos). The content of asbestos in the friction material composition for an underlying material of the present invention is preferably 0.2 mass % or less and more preferably substantially 0 mass %.

Hereinafter, each component of the friction material composition for an underlying material of the present invention will be sequentially described.

### (Bonding Material)

The bonding material has a function of bonding and integrating an organic filler, an inorganic filler, a fibrous base material, and the like which can be comprised in the friction material composition for an underlying material, in one piece, thereby providing predetermined shape and strength. The bonding material comprised in the friction material composition for an underlying material of the present invention is not limited, and a thermosetting resin commonly used in a bonding material for an underlying material can be used.

Examples of the thermosetting resin include a phenolic resin, a modified phenolic resin, an elastomer dispersed phenolic resin, an epoxy resin, a polyimide resin, and a melamine resin. Examples of the modified phenolic resin include an acrylic-modified phenolic resin, a silicone-modified phenolic resin, a cashew-modified phenolic resin, an epoxy-modified phenolic resin, and an alkyl benzene-modified phenolic resin. Examples of the elastomer dispersed phenolic resin include an acrylic elastomer dispersed phenolic resin and a silicone elastomer dispersed phenolic resin.

A phenolic resin, an acrylic-modified phenolic resin, a silicone-modified phenolic resin, and an alkyl benzene-modified phenolic resin are preferred, and a phenolic resin is more preferred because such resins provide particularly favorable heat resistance, moldability, and friction coefficient.

The phenolic resin for use in the bonding material is preferably a heat-melting phenolic resin in terms of moldability of the friction material composition for an underlying material. The “heat-melting” is defined as the nature of mutual fusion of a particulate phenolic resin in insertion of 5 g of a particulate phenolic resin between two stainless steel plates having a thickness of 0.2 mm and then pressing of the resultant by a pressing machine warmed to 100° C. at a total load of 50 kg for 2 minutes.

The thermosetting resin may be used alone or in combination of two or more.

The content of the bonding material in the friction material composition for an underlying material is preferably 5 to 35 mass %, more preferably 5 to 30 mass %, and further preferably 10 to 30 mass % in the friction material composition for an underlying material. In a case where the content of the bonding material is in the range, an underlying material can maintain strength to allow deterioration in vibration-damping properties, for example, squeal due to an increase in elasticity modulus, to be more suppressed.

### (Organic Filler)

The organic filler can exhibit a function as a friction modifier for enhancements in, for example, vibration-damping properties and abrasion resistance. The organic filler in the present invention here does not comprise any fibrous filler (for example, an organic fiber described below). The organic filler may be used alone or in combination of two or more.

The organic filler here used can be any organic filler for use in a common friction material composition, and examples thereof include cashew particles, rubber, and melamine dust. The organic filler here used is also preferably a non-heat-melting phenolic resin. In particular, cashew particles, rubber, and a non-heat-melting phenolic resin are preferable in terms of stability of friction coefficient and an improvement in and abrasion resistance, and in terms of suppression of squeal.

The organic filler here used may also be a combination of cashew particles with rubber, or cashew particles covered with rubber.

The cashew particles are obtained by pulverizing a hardened product of cashew nut shell oil, and may also be commonly referred to as “cashew dust”.

Cashew particles are commonly classified to, for example, brown, black or brown, and black cashew particles depending on the type of a curing agent for use in a curing reaction. Cashew particles can be adjusted in, for example, molecular weight to thereby allow for easy control of not only heat resistance and sound vibration properties, but also, for example, film forming properties to a rotor as a counterpart material.

The average particle size of the cashew particles is preferably 850 μm or less, more preferably 750 μm or less, and further preferably 600 μm or less in terms of dispersibility. The lower limit of the average particle size of the cashew particles is not limited, and may be 200 μm or more, 300 μm or more, or 400 μm or more. The average particle size herein means the value of d50 (median size, cumulative median value, in a volume distribution), as measured according to a laser diffraction particle size distribution measuring method, and much the same is true on the following. For example, the average particle size can be measured with a laser diffraction/scattering particle size distribution measuring apparatus, trade name: LA.920 (manufactured by HORIBA Ltd.).

The cashew particles may be used alone or in combination of two or more.

In a case where the friction material composition for an underlying material of the present invention comprises the cashew particles, the content is preferably 0.5 to 15 mass %, more preferably 1 to 10 mass %, and further preferably 2 to 5 mass %. A content of 0.5 mass % or more tends to result in an improvement in water repellency of the friction material and a disc rotor surface, and also enables proper flexibility to be given to the friction material, thereby resulting in a tendency to improve sound vibration properties. A content of 15 mass % or less tends to result in prevention of deteriorations in heat resistance and cracking resistance.

Examples of the rubber include any rubber for use in a common friction material composition, examples include natural rubber and synthetic rubber, and examples of the synthetic rubber include respective pulverized powders of acrylonitrile-butadiene rubber (NBR), acrylic rubber, isoprene rubber, polybutadiene rubber (BR), styrene/butadiene rubber (SBR), silicone rubber, and tire tread rubber. Among them, respective pulverized powders of acrylonitrile-butadiene rubber (NBR) and tire tread rubber are preferable in terms of the balance among heat resistance, flexibility and production cost.

In a case where the friction material composition for an underlying material of the present invention comprises rubber, the content is not limited as long as the total content of the bonding material, the organic filler, and the organic fiber is 30 mass % or more, and the content is preferably 1 to 30 mass %, more preferably 2 to 25 mass %, further preferably 7 to 23 mass %, and particularly preferably 15 to 25 mass % in the friction material composition for an underlying material. A content of the rubber, of 1 mass % or more, tends to result in an enhancement in durability of the back plate after repeated braking, and a content of 30 mass % or less tends to result in avoidance of deterioration in strength of the underlying material by itself.

The “non-heat-melting” with respect to the non-heat-melting phenolic resin is defined as no mutual fusion of a particulate phenolic resin in insertion of 5 g of a particulate phenolic resin between two stainless steel plates having a thickness of 0.2 mm and then pressing of the resultant by a pressing machine warmed to 100° C. at a total load of 50 kg for 2 minutes.

The non-heat-melting phenolic resin has the property of not being molten by heat, and an increase in amount thereof to be added can also suppress the occurrence of burr. The non-heat-melting phenolic resin is also excellent in affinity with the bonding material, and thus can strengthen the adhesion interface between the organic filler and the bonding material in the resulting molded article, and can enhance mechanical strength of the underlying material. Therefore, the friction material composition for an underlying material of the present invention can comprise the non-heat-melting phenolic resin, resulting in an enhancement in durability of the back plate, with productivity and mechanical strength of the underlying material being kept favorable.

The non-heat-melting phenolic resin may be used alone or in combination of two or more.

The solubility in boiling methanol of the non-heat-melting phenolic resin is preferably 20% or less and more preferably 10% or less. The non-heat-melting phenolic resin may be one not soluble in boiling methanol.

The “solubility in boiling methanol” herein means the content of a component soluble in boiling methanol in the non-heat-melting phenolic resin, and is specifically defined as a value calculated from the following test.

About 10 g (initial mass) of the non-heat-melting phenolic resin is accurately weighed, and heated under reflux in about 500 mL of substantially anhydrous methanol for 30 minutes, thereafter the resultant is filtered by a No. 3 glass filter, and the residue on the glass filter is washed with about 100 mL of anhydrous methanol. Next, the residue on the glass filter after washing is dried at 40° C. for 5 hours, and thereafter the residue is accurately weighed. The value calculated according to the following expression (I) is defined as the “solubility in boiling methanol”.

Solubility in boiling methanol (mass %)=(Difference between initial mass of non-heat-melting phenolic resin and mass of residue after drying)×100/(Initial mass of non-heat-melting phenolic resin) (I)

The non-heat-melting phenolic resin is obtained in the form of a reaction product of a phenol compound and an aldehyde compound.

Examples of the phenol compound include phenol, naphthol, hydroquinone, resorcin, xylenol, and pyrogallol. Among them, phenol is preferable.

Examples of the aldehyde compound include formaldehyde, paraformaldehyde, glyoxal, and benzaldehyde. Among them, formaldehyde and paraformaldehyde are preferable.

The phenol compound and the aldehyde compound may be each used alone or in combination of two or more.

The average particle size of the non-heat-melting phenolic resin is preferably 1 to 50 μm, more preferably 5 to 40 μm, and further preferably 10 to 30 μm.

The shape of the non-heat-melting phenolic resin is not limited, and is preferably spherical.

The sphericity of the non-heat-melting phenolic resin is preferably 0.5 or more.

The “sphericity” herein means the arithmetic average value calculated using the ratio of the shortest diameter/the longest diameter of each particle in observation of shapes of fifty particles of the non-heat-melting phenolic resin with a scanning electron microscope.

The method for producing the non-heat-melting phenolic resin is not limited, and examples thereof include a method involving reacting the aldehyde compound and the phenol compound in an aqueous medium to thereby form a particulate phenolic resin, heating a reaction liquid comprising the particulate phenolic resin to thereby form the particulate phenolic resin into a non-heat-melting phenolic resin, and then isolating the non-heat-melting phenolic resin. More specific examples of the method for producing the non-heat-melting phenolic resin include respective methods described in JP 57-177011 A and WO 2008/047700.

The non-heat-melting phenolic resin preferably has a methylol group. A methylol group is a functional group capable of serving as a reaction point of the bonding material with the phenolic resin or the like, and the reaction strengthens the adhesion interface between the organic filler and the bonding material, resulting in much more excellent mechanical strength of the underlying material. The presence of a methylol group can be confirmed by the presence of an absorption peak at 990 to 1015 cm⁻¹, assigned to a methylol group, in an infrared absorption spectrum according to the KBr tablet method. The amount of a methylol group is not limited, and the ratio [D_{990 to 1015}/D₁₆₀₀] of the intensity D₉₉₀ to 1015 of an infrared absorption peak at 990 to 1015 cm⁻¹, assigned to a methylol group, to the intensity D₁₆₀₀ of an infrared absorption peak at 1600 cm⁻¹, assigned to a benzene nucleus, is preferably in the range from 0.2 to 9.0.

In a case where the friction material composition for an underlying material of the present invention comprises the non-heat-melting phenolic resin, the content is not limited as long as the total content of the bonding material, the organic filler, and the organic fiber is 30 mass % or more, and the content is preferably 0 to 30 mass %, more preferably 1 to 25 mass %, further preferably 6 to 25 mass %, and particularly preferably 12 to 25 mass % in the friction material composition for an underlying material. The non-heat-melting phenolic resin is comprised, thereby resulting in tendency to not only enhance durability of the back plate after repeated braking, but also enhance strength of the underlying material.

The content of the organic filler in the friction material composition for an underlying material is not limited as long as the total content of the bonding material, the organic filler, and the organic fiber is 30 mass % or more, and the content is preferably 10 mass % or more, more preferably 10 to 50 mass %, further preferably 15 to 40 mass %, and particularly preferably 20 to 40 mass % in the friction material composition for an underlying material. A content of the organic filler, of 10 mass % or more, tends to result in an enhancement in durability of the back plate after repeated braking, and a content of 40 mass % or less tends to result in avoidance of deterioration in strength of the underlying material by itself.

### (Fibrous Base Material; Organic Fiber and Inorganic Fiber)

The fibrous base material exerts a reinforcing effect in the underlying material. Examples of the fibrous base material include an organic fiber and an inorganic fiber. The fibrous base material may be used alone or in combination of two or more.

### —Organic Fiber—

The organic fiber is a fibrous material comprising an organic substance as a main component.

Examples of the organic fiber include hemp, cotton, an aramid fiber, a cellulose fiber, an acrylic fiber, and a phenolic resin fiber (having a crosslinked structure).

The organic fiber may be used alone or in combination of two or more.

The organic fiber is preferably an aramid fiber in terms of heat resistance. The organic fiber here comprised is preferably a fibrillated organic fiber and more preferably a fibrillated aramid fiber in terms of an enhancement in strength of the underlying material. Such a fibrillated organic fiber is an organic fiber which is separated and fluffed, and can be commercially available. The friction material composition for an underlying material of the present invention may, of course, comprise not only such a fibrillated organic fiber, but also other organic fiber.

The content of the organic fiber in the friction material composition for an underlying material of the present invention is not limited as long as the total content of the bonding material, the organic filler, and the organic fiber is 30 mass % or more, and the content is preferably 1 to 15 mass %, more preferably 3 to 13 mass %, and further preferably 7 to 13 mass % in the friction material composition for an underlying material. A content of 1 mass % or more tends to result in an enhancement in durability of the back plate after repeated braking, and a content of 13 mass % or less tends to result in avoidance of deterioration in strength of the underlying material by itself.

In the present invention, the friction material composition for an underlying material comprises 30 mass % or more in total of the bonding material, the organic filler, and the organic fiber, as described above, in terms of durability of the back plate after repeated braking. The content is preferably 30 to 85 mass %, more preferably 30 to 80 mass %, further preferably 35 to 80 mass %, particularly preferably 40 to 80 mass %, and most preferably 50 to 80 mass %, and may be 60 to 80 mass % from the same viewpoint.

### —Inorganic Fiber—

The inorganic fiber can exert the effect of enhancing mechanical strength and abrasion resistance of the underlying material.

Examples of the inorganic fiber include a glass fiber, fibrous wollastonite, a metallic fiber, a mineral fiber, a carbon fiber, a ceramic fiber, a biodegradable ceramic fiber, rock wool, a potassium titanate fiber, a silica/alumina fiber, and a flameproof fiber.

The inorganic fiber is preferably a fibrous material comprising an inorganic substance other than a metal and a metal alloy, as a main component, and is more preferably a mineral fiber.

The inorganic fiber may be used alone or in combination of two or more.

The glass fiber refers to a fiber produced by melting and spinning glass. The glass fiber here used can be any fiber with E glass, C glass, S glass, D glass, or the like as a raw material, and, in particular, a glass fiber comprising E glass or S glass is preferably used because of being high in strength. A glass fiber whose surface is treated with aminosilane, epoxysilane, or the like is also preferable for an enhancement in affinity with the bonding material. A glass fiber which is bundled with a urethane resin, an acrylic resin, a phenolic resin, or the like can be used in terms of an enhancement in handleability of a raw material and the friction material composition for an underlying material, and the number of such fibers bundled is preferably 50 to 1,000, and is more preferably 50 to 500 in terms of the balance between dispersibility and handleability.

The average fiber length of the glass fiber is not limited, and is preferably 80 to 6,000 μm, more preferably 150 to 5,000 μm, further preferably 300 to 5,000 μm, particularly preferably 1,000 to 5,000 μm, and most preferably 2,000 to 4,000 μm. An average fiber length of 80 μm or more tends to result in an enhancement in strength of the underlying material, and an average fiber length of 6,000 μm or less tends to result in suppression of deterioration in dispersibility. The average fiber size of the glass fiber is preferably 5 to 20 μm and more preferably 7 to 15 μm. An average fiber size of 5 μm or more enables breakage of the glass fiber in mixing of the friction material composition for an underlying material to be suppressed, and an average fiber size of 20 μm or less tends to result in an enhancement in strength of the underlying material. The average fiber length and the average fiber size herein can each represent the average value determined by randomly selecting fifty of such inorganic fibers used, and measuring the fiber length and the fiber size of each of such fibers with an optical microscope, and the catalog values can also be seen in the case of a commercially available product. The fiber size herein refers to the fiber diameter.

The fibrous wollastonite refers to one obtained by pulverizing and classifying silicate mineral naturally produced, comprising CaSiO₃ as a main component, and processing it into a fiber. The average aspect ratio (average fiber length/average fiber size) of the fibrous wollastonite for use in the present invention is preferably 8 or more, more preferably 8 to 20, further preferably 9 to 20, and particularly preferably 10 to 18. An average aspect ratio of 8 or more can allow the underlying material to be effectively enhanced in shear strength and cracking resistance at ordinary temperature and high temperature. The average aspect ratio means the d50 value (cumulative median value in a volume distribution), and can be measured according to, for example, a dynamic image analysis method.

The average fiber length of the fibrous wollastonite is preferably 20 to 1,000 μm, more preferably 40 to 850 μm, and further preferably 100 to 850 μm in terms of strength provided to the underlying material. The average fiber size of the fibrous wollastonite is preferably 70 μm or less and more preferably 60 μm or less in terms of strength provided to the underlying material. The lower limit of the average fiber size is not limited, and is preferably 5 μm or more and more preferably 8 μm or more. The surface of the fibrous wollastonite may be treated with aminosilane, epoxysilane, or the like for the purpose of an enhancement in affinity with the bonding material.

Examples of the metallic fiber include a fiber in the form of a metal simple substance such as aluminum, iron, zinc, tin, titanium, nickel, and magnesium, or in the form of an alloy thereof, and a fiber comprising a metal such as cast iron, as a main component. Examples of the fiber in the form of an alloy (alloy fiber) include an iron alloy fiber and an aluminum alloy fiber. The metallic fiber may be used alone or in combination of two or more. In the present invention, a friction material composition for an underlying material, comprising no metallic fiber, is preferable.

A copper fiber, a copper alloy fiber, an iron fiber, and an iron alloy fiber are commonly preferred in terms of an enhancement in strength, stability of friction coefficient, an enhancement in heat conductivity, and enhancements in cracking resistance and abrasion resistance. However, a case where a copper fiber or a copper alloy fiber is comprised has the problem of environmental pollution, as described above, thus the content of copper in the friction material composition for an underlying material of the present invention is less than 0.5 mass % in terms of a copper element, and is preferably 0.3 mass % or less and more preferably 0.1 mass % or less, and an embodiment is further preferable where substantially no copper is comprised. Examples of the copper alloy fiber include a copper fiber, a brass fiber, and a bronze fiber.

In a case where an iron fiber or an iron alloy fiber is comprised, the content of iron in the friction material composition for an underlying material of the present invention is preferably less than 0.5 mass %, more preferably 0.3 mass % or less, and further preferably 0.1 mass % or less in terms of an iron element, and an embodiment is particularly preferable where substantially no iron is comprises, in order that deterioration in durability due to rusting at the adhesion interface with the back plate is suppressed.

The mineral fiber is an artificial inorganic fiber obtained by melting and spinning, for example, blast furnace slag such as slag wool, basalt rock such as a basalt fiber, or other natural rock, as a main component. Examples of the mineral fiber include a mineral fiber comprising SiO₂, Al₂O₃, CaO, MgO, FeO, Na₂O, or the like, and a mineral fiber comprising one or more of such compounds. The mineral fiber is preferably a mineral fiber comprising an aluminum element, more preferably a mineral fiber comprising Al₂O₃, and further preferably a mineral fiber comprising Al₂O₃ and SiO₂.

A longer average fiber length of the mineral fiber comprised in the friction material composition for an underlying material tends to result in more deterioration in shear strength. The average fiber length of the mineral fiber is preferably 500 μm or less, more preferably 100 to 400 μm, and further preferably 120 to 340 μm. The average fiber size (diameter) of the mineral fiber is not limited, and is usually 1 to 20 μm and may be 2 to 15 μm.

The mineral fiber is preferably biosoluble in terms of the harmful effect on a human body. The biosoluble mineral fiber here referred to is a mineral fiber having the feature of being partially degraded in a short time and eliminated from the body even if entering a human body. Specifically, the biosoluble mineral fiber denotes any fiber (see Nota Q (excluding carcinogenicity) in EU Directive 97/69/EC) which has a chemical composition where the total amount of an alkali oxide and an alkaline earth oxide (the total amount of oxides of sodium, potassium, calcium, magnesium, and barium) is 18 mass % or more, and which satisfies any of (a) the half-life of a fiber having a length of more than 20 μm being less than 10 days in the in vivo durability test by short-term inhalation exposure, (b) the half-life of a fiber having a length of more than 20 μm being less than 40 days in the in vivo durability test by short-term intratracheal instillation, (c) no significant carcinogenicity in the intraperitoneal administration test, or (d) no pathological findings or tumorigenesis associated with carcinogenicity in the long-term inhalation exposure test. Examples of such a biodegradable mineral fiber include a SiO₂—Al₂O₃—CaO—MgO—FeO(—K₂O—Na₂O) fiber, and include a mineral fiber comprising any combination of at least two selected from the group consisting of, for example, SiO₂, Al₂O₃, CaO, MgO, FeO, K₂O, and Na₂O.

Examples of the carbon fiber include a flameproof fiber, a pitch carbon fiber, a PAN carbon fiber, and an activated carbon fiber. The carbon fiber may be used alone or in combination of two or more. The average fiber length of the carbon fiber is not limited, and is preferably 0.1 to 6.0 mm and more preferably 0.1 to 3.0 mm. An average fiber length in the range allows the underlying material to be unlikely to be chipped and allows strength to be easily kept. The average fiber size of the carbon fiber is not limited, and is preferably 5 to 20 μm.

In a case where the friction material composition for an underlying material of the present invention comprises an inorganic fiber (for example, a mineral fiber), the content is preferably 3 to 40 mass %, more preferably 8 to 30 mass %, further preferably 10 to 30 mass %, and particularly preferably 15 to 25 mass % in the friction material composition for an underlying material.

### (Inorganic Filler)

The inorganic filler can exhibit a function as a friction modifier for avoidance of deteriorations in, for example, heat resistance, abrasion resistance, and stability of friction coefficient of the underlying material. The inorganic filler in the present invention here does not comprise any fibrous filler (for example, an inorganic fiber described below). The inorganic filler may be used alone or in combination of two or more.

The inorganic filler is not limited, and may be any inorganic filler for use in a common underlying material. Examples of the inorganic filler include metal sulfides such as antimony trisulfide, tin sulfide, molybdenum disulfide, bismuth sulfide, and zinc sulfide; titanates such as potassium titanate, lithium potassium titanate, sodium titanate, and potassium magnesium titanate; mica, graphite, coke, calcium hydroxide, calcium oxide, sodium carbonate, calcium carbonate, magnesium carbonate, barium sulfate, dolomite, coke, mica, vermiculite, calcium sulfate, particulate potassium titanate, plate-like potassium titanate, talc, clay, zeolite, chromite, zirconium oxide, titanium oxide, magnesium oxide, triiron tetraoxide, zinc oxide, and γ-alumina; and metal powders such as an iron powder, a cast iron powder, an aluminum powder, a nickel powder, a tin powder, a zinc powder, and an alloy powder comprising at least one metal of the above metals, and an inorganic filler comprising neither copper nor an iron-based metal is preferable. Among them, at least one selected from the group consisting of metal sulfides, titanates, mica, graphite, calcium hydroxide, and barium sulfate may be adopted, and barium sulfate is preferable.

The graphite is not limited, known graphite, namely, any of natural graphite and artificial graphite can be used, and the content is preferably 5 mass % or less, more preferably 3 mass % or less, further preferably 2 mass % or less, and particularly preferably substantially 0 mass % in the friction material composition for an underlying material, in order that an increase in heat conductivity of the underlying material is suppressed.

In a case where the friction material composition for an underlying material of the present invention comprises barium sulfate, the content is not limited, and corresponds to the “balance” for adjusting the total amount of the friction material composition for an underlying material, together with the amount of other components blended, to 100 parts by mass.

In a case where the friction material composition for an underlying material of the present invention comprises an inorganic filler, the content is preferably 20 to 75 mass %, more preferably 30 to 70 mass %, further preferably 40 to 65 mass %, and particularly preferably 40 to 60 mass % in the friction material composition for an underlying material. A content of the inorganic filler in the range allows deterioration in heat resistance to be easily avoided. The upper limit of the content of the inorganic filler may be 55 mass % or less.

### (Other Materials)

Other materials, in addition to the above components, can be, as necessary, blended in the friction material composition for an underlying material of the present invention.

Examples of such other materials include metal powders such as a zinc powder and an aluminum powder; and organic additives including a fluoropolymer such as polytetrafluoroethylene (PTFE) in terms of enhancements in abrasion resistance and heat fade characteristics.

In a case where the friction material composition for an underlying material of the present invention comprises such other material, the content of each of such materials in the friction material composition for underlying material is preferably 20 mass % or less, more preferably 10 mass % or less, and further preferably 5 mass % or less, particularly preferably 1 mass % or less, and no such other materials may be comprised.

Next, a friction material (overlying material) 2 to be provided on the underlying material is described in detail. Each component that can be comprised in the “friction material composition for an overlying material” corresponds to a component that can be comprised in a “friction material (overlying material)”. In other words, the description about each component in a “friction material composition for an overlying material” described below can be read as the description about each component in an “overlying material”.

### [Friction Material Composition for Overlying Material]

A friction material composition for an overlying material, serving as the material of the friction material (overlying material) 2, can be any known friction material composition for an overlying material, and is not limited. The friction material composition for an overlying material is specifically a friction material composition for an overlying material, comprising an organic filler, an inorganic filler, a fibrous base material, and a bonding material, and the friction material composition for an overlying material preferably comprises no copper or comprises copper at a content of less than 0.5 mass % in terms of a copper element. The organic filler, the inorganic filler, the fibrous base material, and the bonding material here used can be the same as those described in the friction material composition for an underlying material.

### (Method for Producing Friction Material 2 and Underlying Material 3)

The description is made with reference to FIG. 3. The friction material composition for an overlying material and the friction material composition for an underlying material of the present invention can be molded by a method commonly used, preferably heat and pressure molding, thereby integrating the overlying material (friction material) 2 and the underlying material 3 in one piece.

More specifically, the overlying material (friction material) 2 and the underlying material 3 can be integrated in one piece by separately mixing the friction material composition for an overlying material and the friction material composition for an underlying material of the present invention by use of a mixing machine such as a Loedige mixer (“Loedige” is a registered trademark), a pressure kneader, or an Eirich mixer (“Eirich” is a registered trademark), integrally preforming a mixture for the overlying material and a mixture for the underlying material in a metal mold, then molding the resulting preformed article in conditions of, for example, a molding temperature of 130 to 160° C. and a molding pressure of 20 to 50 MPa for 2 to 10 minutes, and subjecting the resulting molded article to, for example, a heat treatment at 150 to 250° C. for 2 to 10 hours. As necessary, painting, a scorching treatment, and/or a polishing treatment may be performed. The preforming step among the above steps may be omitted and the mixtures may be directly subjected to thermoforming.

### [Friction Member]

The description is made with reference to FIG. 3. The friction material composition for an underlying material of the present invention can be used as the underlying material 3 for a friction member because the friction material composition has high shear strength, high cracking resistance, and excellent abrasion resistance at ordinary temperature and high temperature and also enhances durability of the back plate after repeated braking. The overlying material (friction material) 2 is a friction material serving as a friction surface of a friction member, and the underlying material 3 is a layer which is interposed between the overlying material (friction material) 2 serving as a friction surface of a friction member and the back plate 1 and which is for enhancements in shear strength and cracking resistance near the adhesion portion between the overlying material (friction material) 2 and the back plate 1.

The friction member of the present invention is a friction member formed so that the overlying material serves as a friction surface with the underlying material of the present invention being used, in other words, a friction member in which the underlying material is located opposite to a friction surface. The friction member of the present invention is not limited to the embodiment, and examples include (1) a friction member (which is the same as the above embodiment.) comprising the friction material (overlying material) 2, the back plate 1, and the underlying material 3, in which the overlying material 2 is provided through the underlying material 3 on the back plate 1 so as to be located with serving as a friction surface, and (2) a friction member having the configuration (1), in which a primer layer for the purpose of surface modification for an enhancement in adhesion effect of the back plate 1 is interposed between the back plate 1 and the underlying material 3. Examples further include (3) a friction member having the configuration (1) or (2), which has a shim on a side of the back plate 1, opposite to a side on which the underlying material 3 is provided. The shim is a spacer to be commonly used for enhancements in vibration-damping properties of the friction member.

The thickness of the friction material (overlying material) 2 is preferably 4 to 15 mm, more preferably 6 to 15 mm, and further preferably 7 to 13 mm in terms of durability.

The thickness of the underlying material 3 is preferably 1 mm or more, more preferably 1 to 5 mm, and further preferably 2 to 4 mm.

The proportion of the thickness of the underlying material 3 to the total thickness of the overlying material (friction material) 2 and the underlying material 3, in observation in a perpendicular direction from a friction surface, is preferably 3 to 70%, more preferably 5 to 60%, and further preferably 6 to 50%.

The friction member of the present invention can be used as a friction member of a disc brake pad for automobiles or the like, or a friction member of a brake lining for automobiles or the like. The friction member can also be used as a friction member of a clutch facing, an electromagnetic brake, a holding brake, or the like, by performing a step of subjecting the friction material composition for an overlying material and the friction material composition for an underlying material of the present invention to molding, processing, pasting, or the like so that an intended shape is obtained.

The friction member of the present invention is suitable in particular as a friction member for vehicles because the underlying material thereof can allow both shear strength and cracking resistance at ordinary temperature and high temperature to be satisfied and is also excellent in abrasion resistance.

### [Vehicle]

The present invention also provides a vehicle comprising the friction member of the present invention. Examples thereof include a vehicle in which the friction member of the present invention is used for a disc brake pad, a brake lining, a clutch facing, an electromagnetic brake, a holding brake, or the like. Examples of the vehicle include a large automobile, a medium automobile, a standard-sized automobile, a large special-purpose vehicle, a small special-purpose vehicle, a large motorcycle, and a standard-sized motorcycle.

### EXAMPLES

Hereinafter, the present invention will be described in detail with reference to Examples. However, the present invention is not limited to these Examples.

Each friction material sample of Examples and Comparative Examples was evaluated according to the following evaluation methods.

### [Evaluation Methods]

(1) Measurement of Shear Strength

The shear strength at ordinary temperature (25° C.) of each disc brake pad produced in Examples and Comparative Examples was measured according to JIS D4422 (2007).

(2) Heat Conductivity

A measurement sample was prepared by molding an underlying material independently from each other in each Example and then cutting them into a columnar shape having a diameter of 50 mm and a thickness of 2 mm. A bottom surface of the prepared measurement sample was sandwiched by two metallic columns, and the measurement was performed under atmospheric pressure at room temperature (25° C.) using a temperature gradient method (heat conductivity measurement device “ARC-TC-1” manufactured by AGNE Gijutsu Center Inc.). At this time, a temperature difference between the two metallic columns which were in contact with the sample was 13 to 20° C. and an average temperature was 25° C.

The heat conductivity of the back plate was represented as the nominal value in Table 2.

(3) Durability Test of Back Plate and Temperature of Back Plate in Repeated Braking

A brake dynamometer test was conducted using a disc brake pad prepared in each Example, and durability of the back plate was evaluated. In the evaluation, a commonly used pin slide-type colette caliper and a ventilated disc rotor were used in the condition of an inertia of 7 kgf·m·s². After a brake disc temperature was repeatedly increased to 600° C. for 50 times by performing repeated braking for 50 times at a vehicle speed of 65 km/h and a deceleration of 0.35 G, the back plate portion was checked for defects (breakage, deformation, and crack) in appearance and was evaluated in accordance with the following evaluation criteria. Further, a temperature of the back plate was measured with a thermocouple implanted in the back plate. The evaluation results are shown in Table 1.

a: No breakage, no deformation of more than 1 mm, and no formation of a crack on the back plate portion.
b: Although breakage and deformation of more than 1 mm were not observed, formation of a crack was observed on the back plate portion.
c: Breakage or deformation of more than 1 mm was observed on the back plate portion.

### [Production of Disc Brake Pad]

The following components of each friction material composition were prepared for production of a disc brake pad. The respective components described in Table 1 and Table 2 are the same as follows.

### (Bonding Material)

Phenolic resin (heat-melting)

### (Organic Filler)

Cashew particles
Non-heat-melting phenolic resin
Pulverized powder of tire tread rubber
NBR

### (Organic Fiber)

Aramid fiber: fibrillated aramid fiber

### (Inorganic Filler)

Potassium titanate
Zirconium oxide
Mica
Graphite
Tin sulfide
Barium sulfate
Calcium hydroxide

### (Inorganic Fiber)

Mineral fiber: average fiber length 230±50 μm

### Examples 1 to 8 and Comparative Example 1

The components were blended according to the amount blended, represented in Table 1, thereby providing each friction material composition for an overlying material. The components were blended according to the amount blended, represented in Table 2, thereby providing each friction material composition for an underlying material.

The friction material composition for an overlying material and the friction material composition for an underlying material were separately mixed by a “Loedige (registered trademark) mixer M20” (trade name, manufactured by MATSUBO Corporation), thereby providing a mixture for the overlying material and a mixture for the underlying material. The resulting mixture for the overlying material and mixture for the underlying material were integrally preformed in a molding press (manufactured by Oji Machine Co., Ltd.). The resulting preformed article was heat- and pressure-molded together with the back plate comprising the material represented in Table 2 by use of a molding press (manufactured by Sanki Seiko Co., Ltd.) in conditions of a molding temperature of 140 to 160° C., a molding pressure of 30 MPa, and a molding time of 5 minutes. The resulting molded product was subjected to a heat treatment at 200° C. for 4.5 hours, polished by use of a rotary polishing machine, and subjected to a scorching treatment at 500° C., thereby providing a disc brake pad. Each disc brake pad obtained in Examples and Comparative Examples had a thickness of the back plate, of 6 mm, a thickness of the overlying material, of 6 mm, a thickness of the underlying material, of 2 mm, and a project area of the friction material, of 52 cm².

The resulting disc brake pad was subjected to each measurement and evaluation according to the above methods. The results are shown in Table 2.

TABLE 1

| | | | |
|---|---|---|---|
| Friction | Bonding material | Phenolic resin | 10 |
| material | Organic filler | Cashew particles | 5 |
| composition | | Pulverized powder of | 5 |
| for overlying | | tire tread rubber | |
| material | Inorganic filler | Potassium titanate | 20 |
| | | Zirconium oxide | 10 |
| | | Mica | 5 |
| | | Graphite | 5 |
| | | Tin sulfide | 5 |
| | | Barium sulfate | 23.5 |
| | | Calcium hydroxide | 1.5 |
| | Fibrous base | Aramid fiber | 5 |
| | material | Mineral fiber | 5 |

Unit of amount blended: parts by mass

TABLE 2

| | | | | | | | | | | | Com- |
|---|---|---|---|---|---|---|---|---|---|---|---|
| | | | | | | | | | | | parative |
| | | | Examples | | | | | | | | Example |
| | | | 1 | 2 | 3 | 4 | 5 | 6 | 7 | 8 | 1 |
| Back | Material | | Al | Al | Al | Al | Al | Al | Al | GFRP | Al alloy |
| plate | | | alloy | alloy | alloy | alloy | alloy | alloy | alloy | | |
| | Heat conductivity in thickness | | 96 | 96 | 96 | 96 | 96 | 96 | 96 | 0.4 | 96 |
| | direction (W/m·K) | | | | | | | | | | |
| Friction | Bonding | Phenolic resin | 15 | 15 | 15 | 15 | 15 | 25 | 25 | 25 | 15 |
| material | material | | | | | | | | | | |
| composition | Organic | Cashew particles | 3 | 3 | 3 | 3 | 3 | 3 | | | 3 |
| for | filler | Non-heat-melting | 5 | 10 | 20 | | | | 15 | 15 | |
| underlying | | phenolic resin | | | | | | | | | |
| material | | NBR | 3 | 3 | 3 | 3 | 10 | 20 | 20 | 20 | 3 |
| | Organic fiber | Aramid fiber | 5 | 5 | 5 | 10 | 5 | 5 | 10 | 10 | 5 |
| | [Total content | bonding material, | 31 | 36 | 46 | 31 | 32 | 53 | 70 | 70 | 26 |
| | of organic | organic fiber | | | | | | | | | |
| | filler, and | | | | | | | | | | |
| | (mass%)] | | | | | | | | | | |
| | Inorganic | Barium sulfate | 49 | 44 | 34 | 49 | 47 | 27 | 10 | 10 | 54 |
| | filler | | | | | | | | | | |
| | Inorganic | Mineral fiber | 20 | 20 | 20 | 20 | 20 | 20 | 20 | 20 | 20 |
| | fiber | | | | | | | | | | |

| | | | | | | | | | | |
|---|---|---|---|---|---|---|---|---|---|---|
| Results of | Shear strength | 44 | 43 | 45 | 42 | 36 | 45 | 48 | 48 | 42 |
| measurement and | (kN) | | | | | | | | | |
| evaluation | Heat conductivity | 0.44 | 0.39 | 0.31 | 0.41 | 0.35 | 0.28 | 0.24 | 0.24 | 0.58 |
| | in thickness | | | | | | | | | |
| | direction | | | | | | | | | |
| | of underlying | | | | | | | | | |
| | material (W/m·K) | | | | | | | | | |
| | Durability after | a | a | a | a | a | a | a | a | c |
| | repeated braking | | | | | | | | | |
| | Temperature of | 220 | 208 | 197 | 214 | 201 | 192 | 182 | 195 | 265 |
| | back plate (° C.) | | | | | | | | | |

Unit of amount blended: parts by mass

The followings are the materials of the back plate used in each Example described in Table 2.

Al alloy (aluminum alloy): A5083 (Al—Mg alloy)

GFRP: A phenolic resin composited with a glass fiber of 25 mm (glass fiber: 50 mass %)

According to Examples 1 to 8 in Table 1, the disc brake pad in which a lightweight material having poor heat resistance was used for the back plate and an underlying material comprising 30 mass % or more in total of a bonding material, an organic filler, and an organic fiber was used was high in shear strength, and was high in durability of the back plate even after repeated braking. It was presumed that such high durability of the back plate was due to a reduction in temperature increase of the back plate after repeated braking.

Comparative Example 1 in which an underlying material comprising only less than 30 mass % in total of a bonding material, an organic filler, and an organic fiber was used exhibited considerably deteriorated durability of the back plate after repeated braking.

### INDUSTRIAL APPLICABILITY

The friction member of the present invention has a small temperature increase in the back plate even when braking is performed repeatedly, has practical durability, is light in weight, and is therefore suitable for a disc brake pad used in braking of a two-wheeled vehicle or a four-wheeled automobile.

### REFERENCE SIGNS LIST

1 Back plate
11 Surface of back plate on which friction material is disposed
12 The other surface of back plate
2 Friction material (underlying material)
3 underlying material

1. A friction member in which a friction material (overlying material) is disposed through an underlying material on one surface of a back plate comprising a material having a lower specific gravity than that of steel, wherein the underlying material comprises 30 mass % or more in total of a bonding material, an organic filler, and an organic fiber.

2. The friction member according to claim 1, wherein a content of the organic filler in the underlying material is 10 mass % or more.

3. The friction member according to claim 1, wherein the underlying material further comprises at least one selected from the group consisting of an inorganic filler and an inorganic fiber.

4. The friction member according to claim 1, wherein the specific gravity of the material contained in the back plate is 5 Mg/m³ or less.

5. The friction member according to claim 1, wherein the back plate comprises at least one selected from the group consisting of (1) a fiber-reinforced resin, (2-1) an aluminum alloy, (2-2) an aluminum composite in which ceramic particles are dispersed in aluminum or an aluminum alloy, (3-1) a magnesium alloy, and (3-2) a magnesium composite in which ceramic particles are dispersed in magnesium or a magnesium alloy.

6. The friction member according to claim 5, wherein the back plate comprises the fiber-reinforced resin (1) or the aluminum alloy (2-1).

7. A disc brake pad comprising the friction member according to claim 1.

8. A vehicle comprising the friction member according to claim 1.

9. A friction material composition for an underlying material, wherein the friction material composition comprises 30 mass % or more in total of a bonding material, an organic filler, and an organic fiber.

10. The friction material composition for an underlying material according to claim 9, wherein a content of the organic filler is 10 mass % or more.

11. The friction material composition for an underlying material according to claim 9, further comprising at least one selected from the group consisting of an inorganic filler and an inorganic fiber.

12. The friction material composition for an underlying material according to claim 9, wherein the friction material composition comprises no copper, or, even if comprising copper, comprises copper at a content of less than 0.5 mass % in terms of a copper element.

13. An underlying material obtained by molding the friction material composition for an underlying material according to claim 9.

14. A vehicle comprising the underlying material according to claim 13.
